(19) United States
(12) Patent Application Publication
(10) Pub. No.: US 2026/0369927 A1
(43) Pub. Date: Nov. 19, 2026

(54) ROUND PLUG CONNECTOR HAVING DIRECTLY LOCKED LOCKING ELEMENT

(71) Applicant: BELDEN DEUTSCHLAND GMBH, Schalksmühle (DE)

(72) Inventors: Othmar GAIDOSCH, Esslingen a.N. (DE); Rainer DECKER, Aichtal (DE); Nihat KARA, Walddorfhäslach (DE)

(73) Assignee: BELDEN DEUTSCHLAND GMBH, Schalksmühle (DE)

(21) Appl. No.: 19/476,102

(22) PCT Filed: Apr. 11, 2024
(86) PCT No.: PCT/EP2024/059840

§ 371 Date: Oct. 16, 2025

(30) Foreign Application Priority Data
Apr. 17, 2023 (DE) 10 2023 109 550.1

(51) Int. Cl. H01R 13/622; H01R 13/6581; H01R 43/20

(52) U.S. Cl. CPC H01R 13/622; H01R 13/6581; H01R 43/20

(57) ABSTRACT

A plug connector includes an inner part, wherein, coaxially over the inner part, there is a locking element by means of which the plug connector is brought together with and locked with a mating plug connector by a rotational movement of the locking element wherein the locking element is rotatably mounted on the inner part but cannot be moved relative to the inner part along the longitudinal axis of the locking element, wherein the inner part has at least one axially oriented elastic spring fin fixedly attached to the inner part, wherein direct locking of the locking element is made possible by means of the at least one elastic spring fin fixedly attached to the inner part. The inner part, in particular in the form of a contact carrier, is produced from a metal material using the metal injection molding (MIM) process.

The invention relates to a plug connector which has an inner part, in particular a contact carrier for receiving contacts, wherein a locking element is arranged coaxially above the inner part, in particular the contact carrier, by means of which the plug connector is brought together with a mating plug connector and locked by a rotational movement of the locking element, wherein the locking element is rotatably mounted on the inner part, in particular the contact carrier, but is not movable relative to the latter along its longitudinal axis, and further relates to a method of manufacturing such an inner part, in particular such a contact carrier for the plug connector, in accordance with the features of the respective preambles of the two independent patent claims.

For mounting and securing the locking element on the contact carrier, it has already become known to provide the contact carrier with a circumferential groove into which a C-spring is inserted, which is designed in such a way that it forms a locking edge for the locking element in the axial direction, i.e. in the direction of the longitudinal axis of the plug connector. To fit the C-spring, it is pushed over the contact carrier from the front (from the direction of the mating face of the plug connector) and can thereby be slightly compressed by the inner contour of the locking element, so that the locking element can be pushed over the C-spring completely or at least partially. Once this has happened, the inner contour of the locking element no longer causes the C-spring to compress, so that it relaxes. As a result of this relaxation, the C-spring forms a locking edge that interacts with a corresponding locking edge on the inner contour of the locking element, thereby preventing the locking element from being pushed off the contact carrier again. At the same time, this ensures that the locking element is rotatably arranged on the contact carrier. If the mating plug connector is now inserted into the contact carrier of the plug connector, after the plug connectors have been fully joined together, the locking element of the plug connector can be brought together with a corresponding mating piece on the mating plug connector by turning, in particular screwing together, so that the plug connection formed by the plug connector joined together with the mating plug connector can no longer be disconnected.

The object of the invention is therefore to improve the above-mentioned arrangement with regard to its assembly and durability during operation of the plug connector.

This object is achieved by the features of the two independent claims.

With regard to the design of the plug connector, it is provided according to the invention that the inner part has at least one axially oriented elastic spring fin fixedly attached to it, wherein direct locking of the locking element is made possible by means of the at least one elastic spring fin fixedly attached to the inner part. The elasticity of at least one spring fin reduces the force required to assemble the plug connector. After assembly, the end of the at least one spring fin comes into contact with a corresponding geometry of the locking element in order to enable the direct locking of the locking element permanently during operation of the plug connector, i.e. during the mating processes.

The inner part may be the contact carrier that holds the contacts of the plug connector. Alternatively, it is conceivable that the inner part is a separate component in relation to the contact carrier and is arranged coaxially above it. In a shielded plug connector, the inner part is also provided with shielding. This may be a metallic coating, for example. In addition or as an alternative, the inner part may be made entirely of a metallic material. If the plug connector is a shielded plug connector which is arranged at the end of a shielded cable and in which the inner part, in particular the shield housing, consists of a metallic material, it goes without saying that the shielding of the cable is connected to the metallic inner part, in particular the shield housing, in a suitable manner, and thus electrically contacted in order to pass the shielding from the cable through the plug connector to the inserted mating plug connector.

In particular, the invention relates to a round plug connector, and more specifically to round plug connectors for field use. These are often screw-locked or bayonet-locked with their counterpart (mating plug connector).

For this purpose, the plug connector must be equipped with a locking element rotatable about the longitudinal axis, which must be positively mounted or locked in place on the front side of the plug connector housing.

A one-piece locking element that is mounted from the mating face generally has the advantage that the plug connector can be made more compact in the connection area on the cable side.

Shielded round plug connectors for field use require-for functional reasons-a metal housing that is completely enclosed around the insulating contact carrier, to which the corresponding locking element must be attached when mounted on the front. According to the prior art, such shield housings are either machined or die-cast. According to these methods, it is technically and/or economically not possible to provide locking elements fixedly attached to the shield housing. This locking is accomplished with the aid of additional parts, such as so-called C-springs or the like, which in turn leads to higher assembly costs, a greater variety of parts, lower precision in the assembly, and the like.

According to the invention, the plug connector has an inner part that has at least one axially oriented spring fin, preferably two or more than two spring fins, wherein direct locking of the locking element in the axial direction is made possible by means of the at least one elastic spring fin fixedly attached to the housing. At the same time, once the locking element has been mounted and the end position has been reached, the locking element is allowed to rotate in relation to the inner part. In an advantageous manner, the inner part is the contact carrier of the plug connector. However, it is alternatively equally conceivable that the inner part with its at least one axially oriented spring fin (preferably two or more than two spring fins) is arranged coaxially within the locking element, wherein the contact carrier with contacts of the plug connector is in turn arranged coaxially within the inner part. If the above-mentioned elements are made of an electrically non-conductive material (e.g., plastic), it is a non-shielded connector, wherein these elements can be manufactured using a plastic injection molding process.

The subject matter of this application in particular, according to the dependent claim, is a completely closed shield housing which is preferably manufactured from a metallic material using the metal injection molding (MIM) process, and which enables direct locking of the locking element in the axial direction by means of at least one elastic spring fin fixedly attached to the shield housing, but at the same time enables a rotational movement of the locking element. With the metal injection molding process, it is advantageously possible to manufacture the geometrically quite complex inner part with at least one axially oriented elastic spring fin fixedly attached to it in one piece, at low cost.

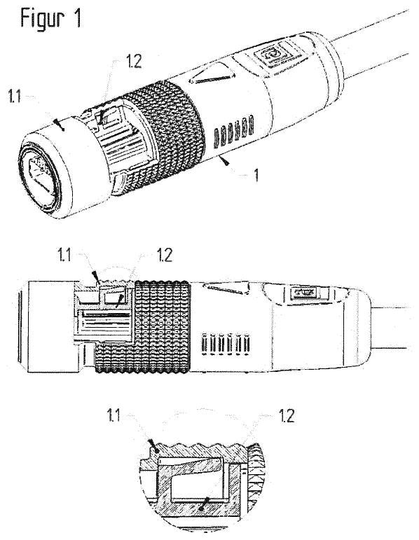

An embodiment according to the invention is shown in FIG. 1 to 3. The connector shown here is a shielded plug connector, although the same designs can also be used for an unshielded plug connector.

FIG. 1 shows, insofar as illustrated in detail, a plug connector 1, in particular a shielded (alternatively unshielded) round plug connector for field use, which has a housing and is arranged at the end of a shielded or unshielded cable. This plug connector 1 has an inner part (not described in more detail), wherein a locking element 1.1 being arranged coaxially above the inner part, with which the plug connector 1 is brought together and locked with a mating plug connector not shown here by a rotational movement of the locking element 1.1, wherein the locking element 1.1 is rotatably arranged on the inner part, but cannot be moved relative to the latter along its longitudinal axis.

Furthermore, the plug connector 1 has a shielded housing (generally referred to as the inner part or contact carrier), which is circumferentially closed and thus coaxially surrounds the inner part or contact carrier at least partially or over its entire longitudinal extent. This is particularly important with a shielded plug connector in order to transfer the shielding from the shielding of the cable through the plug connector to the mating connector.

In addition, the housing in this exemplary embodiment is designed in such a way that, starting from the cable end, a part of the housing is made of plastic, and a further housing part is provided between the end of this housing part and the mating face of the plug connector. This additional housing part may also be made of plastic, or alternatively of a metal material (required for the shielding). It may have a smooth surface or, as shown, a ribbed surface for better handling of the plug connector during the mating process. This further housing part is shown partially open in FIG. 1 to make it easier to recognize the inner area of the plug connector 1, whereas in practice it is completely closed.

This further housing part described above is the locking element 1.1.

In the lower illustration of FIG. 1, it can also be seen that the shield housing 1.2 is sleeve-shaped and has two radially protruding webs. Looking at FIG. 1, the right-hand web forms the end of the shield housing 1.2, whereas the left-hand web is arranged, for example, approximately in the middle of the axial extension of the shield housing 1.2 and has at least one partially or completely circumferential spring fin at its outward-facing end. The corner of the transition from the left web into the at least one spring fin is supported on a projection of the locking element 1.1, just as the free end of the at least one spring fin is supported on a further projection of the locking element 1.1. This ensures that the locking element 1.1 is rotatably arranged on the inner part, but cannot be moved relative to it along its longitudinal axis.

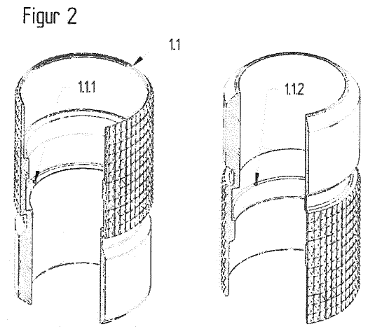

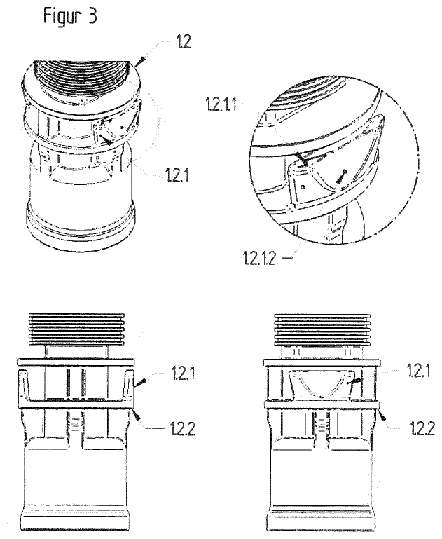

FIG. 2 shows important embodiments of the locking element 1.1. This involves a running surface 1.1.1 required for its rotational movement, which is provided on the shield housing 1.2 in correspondence with the counter-running surface 1.2.2 (see FIG. 3), and a running surface 1.1.2 provided on the shield housing 1.2 in correspondence with the locking fins, which interacts with these to ensure positive locking.

FIG. 3 shows an embodiment of the shield housing 1.2, which is circumferentially closed with at least one spring fin 1.2.1 arranged on it. Preferably, there are several spring fins 1.2.1 for the purpose of uniform force distribution or uniform spring action over the circumference. This elastic spring fin(s) 1.2.1 is (are) fixedly connected to the shield housing 1.2. These elements are preferably manufactured in one piece, again preferably in a casting process from a metallic material, and more preferably using the metal injection molding process (MIM) from a metallic material.

Furthermore, there is (are) at least one (or more) running surface(s) 1.2.1.1, corresponding to the running surface 1.1.2 on the locking element 1.1, on which the positive locking (see FIG. 1, lower illustration) is ensured when the locking element 1.1 is mounted.

The reference number 1.2.1.2 indicates an optional flattening on the spring fin 1.2.1 in order to reduce the assembly force if necessary. The reference number 1.2.2 also designates a counter-running surface corresponding to the running surface 1.1.1 on the locking element 1.1, which also serves as a stop during its assembly.

### LIST OF REFERENCE NUMBERS

1 plug connector
1.1 locking element
1.2 shield housing
1.1.1 running surface
1.1.2 running surface
1.2.1 elastic spring fin
1.2.1.1 running surface
1.2.1.2 flattening
1.2.2 counter-running surface

1. A plug connector comprises an inner part, a locking element arranged coaxially above the inner part, by means of which locking element the plug connector is brought together with a mating plug connector and locked by a rotational movement of the locking element, wherein the locking element is arranged rotatably on the inner part, but cannot be moved relative to the latter along its longitudinal axis, wherein the inner part has at least one axially oriented elastic spring fin fixedly attached to it, wherein the locking element being able to be locked directly by means of the at least one elastic spring fin fixedly attached to the inner part.

2. The plug connector according to claim 1, wherein the inner part is a contact carrier for receiving contacts of the plug connector.

3. The plug connector according to claim 1, wherein the inner part with its at least one axially oriented elastic spring fin is arranged coaxially inside the locking element, wherein the contact carrier with contacts of the plug connector is arranged coaxially inside the inner part.

4. The plug connector according to claim 1, wherein the locking element has a running surface required for its rotational movement, which is provided corresponding to a counter-running surface on the inner part, in particular formed as a shield housing.

5. The plug connector according to claim 1, wherein the locking element has a running surface which is provided corresponding to locking fins on the inner part, in particular the shield housing.

6. The plug connector according to claim 1, wherein the at least one spring fin has a flattening, in particular a partial flattening.

7. A method for manufacturing a plug connector which has an inner part, in particular a contact carrier for receiving contacts, wherein a locking element is arranged coaxially above the inner part, in particular the contact carrier, by means of which locking element the plug connector is brought together with a mating plug connector and locked by a rotational movement of the locking element, wherein the locking element is rotatably mounted on the inner part, in particular the contact carrier, but cannot be moved relative to the latter along its longitudinal axis, wherein the inner part is manufactured from a metallic material using the metal injection molding (MIM) process.

8. The method according to claim 7, wherein a contact carrier for receiving contacts of the plug connector is manufactured from a metallic material as the inner part using the metal injection molding (MIM) process.

9. The method according to claim 7, wherein the inner part is a shield housing with at least one axially oriented elastic spring fin fixedly attached to it, which is manufactured from a metallic material using the metal injection molding process (MIM), wherein the inner part is designed such that a contact carrier for receiving contacts of the plug connector can be inserted into the inner part.

10. The plug connector according to claim 3, wherein the at least one axially oriented elastic spring fin comprises two or more than two spring fins arranged coaxially inside the locking element, wherein the contact carrier with contacts of the plug connector is arranged coaxially inside the inner part.
